(19) United States
(12) Patent Application Publication
(10) Pub. No.: US 2003/0131106 A1
(43) Pub. Date: Jul. 10, 2003

(54) Web-page performance toolbar

(76) Inventor: Stephane Kasriel, San Francisco, CA (US)

Correspondence Address: ROBERT M. MCDERMOTT, ESQ., 1824 FEDERAL FARM ROAD, MONTROSS, VA, 22520, US

(21) Appl. No.: 10/128,595

(22) Filed: Apr. 22, 2002

Related U.S. Application Data
(60) Provisional application No. 60/347,390, filed on Jan. 9, 2002.

(51) Int. Cl. G06F 15/173

(52) U.S. Cl. 709/225

(57) ABSTRACT

A toolbar is provided that is synchronized with a web-site browser system. The toolbar provides an interface to a web-page analysis system that provides performance data related to a select web-page. By synchronizing the toolbar to the browser, the web-page analysis system provides performance data related to the web-page that the browser is currently displaying. By displaying the performance data from the web-page analysis system coincident with the content of the web-page from the browser, the user is provided a direct visual association between the actual web-page and its performance. By synchronizing the toolbar with the browser, the user can view the performance measures of each page as the user navigates through the web-site using the same technology that a typical web-site visitor would use. The toolbar in a preferred embodiment is also configured to provide links to performance data related to other pages of the web-site relative to the currently displayed page.

This application claims the benefit of U.S. Provisional Application No. 60/347,390, filed Jan. 9, 2002, Attorney Docket FC011022A.

### BACKGROUND OF THE INVENTION

1. Field of the Invention

This invention relates to the field of computer networks, and in particular to a system and method that facilitates an analysis of the performance of sites on a network.

2. Description of Related Art

Performance analysis is a necessary tool for effective web-site management and on-going web-site development, as well as for the development of effective marketing strategies. Web-site managers, hereinafter webmasters, desire information that can be used to enhance the web-site's performance or appearance. Electronic-commerce marketing managers, hereinafter marketers, desire information that can be used to enhance the sales resulting from visits to a web-site, to enhance advertising revenue from the web-site, and/or to determine the effectiveness of advertising expenses to other web-site providers.

Tools are commonly available for collecting traffic and performance data associated with pages of a web-site. A fundamental tool, for example, collects data regarding the number of times each page at a web site is accessed within a given period of time (e.g. ‘hit-rate’ statistics). A more sophisticated tool, such as the Netflame™ product from Fireclick, Inc., collects data regarding accesses to each page at a web site, including statistics related to the average time required to download each page, the duration of time that the average visitor remains at each page, the relative frequency of exiting the site via each page, the frequency of backtracking from each page, and so on.

Copending U.S. patent application “PREDICTIVE PRE-DOWNLOAD USING NORMALIZED NETWORK OBJECT IDENTIFIERS”, Ser. No. 09/734,910, filed Dec. 11, 2000 for Stephane Kasriel, Xavier Casanova, and Walter Mann, discloses a preferred technique for determining and downloading the anticipated next-page, and is incorporated by reference herein. Of particular note, this copending application also discloses the concept of a “normalized” web-page, wherein alternative versions of a web-page are analyzed and processed as a single web-page. That is, alternative versions of a web-page may include an element that varies, depending upon the environment, the particular viewer, the class of viewer, a currently advertised special, and so on. Each version may potentially correspond to a different web-page, because each version may have a different URL (Uniform Resource Locator). If processed and analyzed separately, the individual statistics that are associated with each of the different versions of a web-page would generally be meaningless. A normalized web-page comprises all of the non-varying elements of the alternative versions, and the data collected corresponding to each of the alternative versions is associated with the normalized web-page. In this manner, statistics are provided for the web-page, independent of variables associated with the web-page. For ease of reference and understanding, the term web-page as used herein includes a normalized web-page, and other collections of pages, files, and data that form a cohesive entity for traffic-analysis reporting purposes. For example, copending U.S. patent application “PREDICTIVE PREDOWNLOAD OF TEMPLATES WITH DELTA ENCODING, Ser. No. 10/079,932, filed Feb. 19, 2002 for Stephane Kasriel, incorporated by reference herein, discloses the use of “templates” that correspond to the relatively unchanging portions of a web-page, and “delta-encoding” to encode the portions of a web-page that change. As defined herein, the templates with multiple and varied delta-encodings correspond to a web-page. Other examples of collections of material forming a cohesive entity for traffic-analysis will be evident to one of ordinary skill in the art.

The information provided by traffic or performance analysis tools is useful, but access to the information is somewhat cumbersome. Typically, a user types in or selects a URL corresponding to the web-page of interest, and the analysis tool presents the information corresponding to the selected or specified URL. The aforementioned Netflame™ product, presents a graph that displays interconnected pages of a web site, and allows a user to click on a node of the graph to display analysis information related to the selected page. Copending U.S. patent application, “WEB-SITE ANALYSIS SYSTEM”, Ser. No. ______, filed ______ for Stephane Kasriel and Sara Swanson, Attorney Docket FC020116, discloses an analysis system that displays performance statistics related to a selected site, and is incorporated by reference herein. Although this copending application allows a user to associate an ‘alias’ name to each web-page, to display a more meaningful name in the displayed graph of the web-site, compared to the URL of the web-page, there is an inherent disassociation between a labeled node on a graph and the actual web-page. In like manner, there is an inherent disassociation between selecting a labeled node on a graph, compared to actually navigating through the web-site to arrive at the different pages of the web-site.

### BRIEF SUMMARY OF THE INVENTION

It is an object of this invention to provide a web-site analysis system that is consistent with common web-site navigation tools. It is another object of this invention to provide a web-site analysis system that provides for an immediate association between the contents of a web-page and the performance associated with the web-page.

These objects and others are achieved by providing an integration between a web-site performance system and a web-site navigation system. A user is provided a toolbar that is synchronized with a web-site navigation system, such as the Microsoft Internet Explorer or Netscape Navigator browser systems. The toolbar provides an interface to a web-page analysis system that provides performance data related to a select web-page. By synchronizing the toolbar to the browser, the web-page analysis system provides performance data related to the web-page that the browser is currently displaying. By displaying the performance data from the web-page analysis system coincident with the content of the web-page from the browser, the user is provided a direct visual association between the actual web-page and its performance. By synchronizing the toolbar with the browser, the user can view the performance measures of each page as the user navigates through the web-site using the same technology that a typical web-site visitor would use. The toolbar in a preferred embodiment is also configured to provide links to performance data related to other pages of the web-site relative to the currently displayed page.

### BRIEF DESCRIPTION OF THE DRAWINGS

The invention is explained in further detail, and by way of example, with reference to the accompanying drawings wherein:

FIGS. 1A and 1B illustrate an example browser display of two web-pages of a web-site, and a coincident display of performance data related to the displayed web-page in accordance with this invention.

FIG. 2 illustrates an example block diagram of a web-site analysis system that provides a coincident display of performance data related to a web-page that is being displayed by a browser in accordance with this invention.

Throughout the drawings, the same reference numerals indicate similar or corresponding features or functions.

### DETAILED DESCRIPTION OF THE INVENTION

This invention is presented herein using the paradigm of a performance-analysis system having the capabilities of the aforementioned Netflame™ product from Fireclick, Inc. As will be evident to one of ordinary skill in the art, the principles of this invention are applicable to other web-site analysis systems and products.

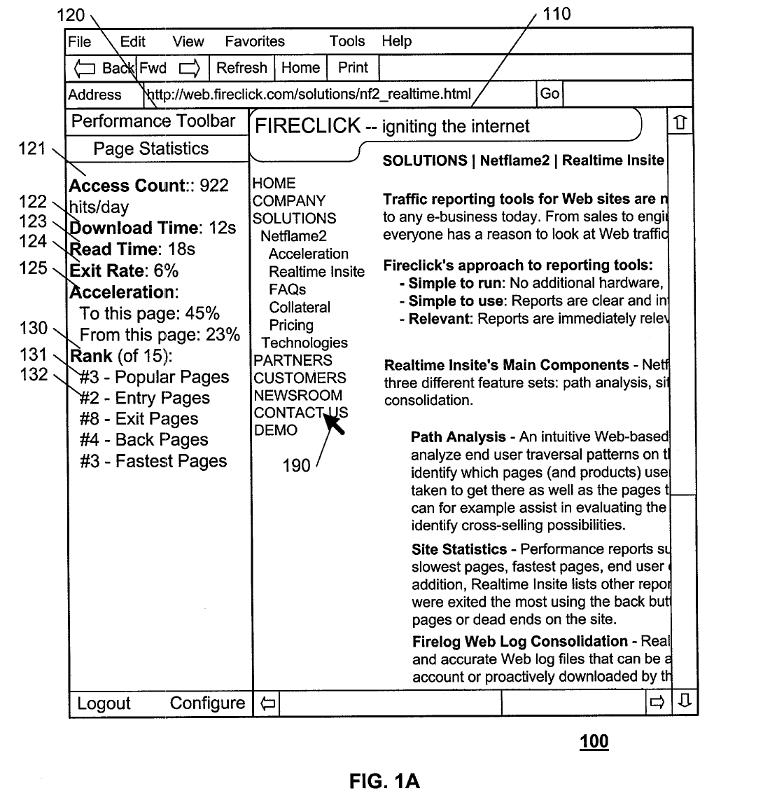

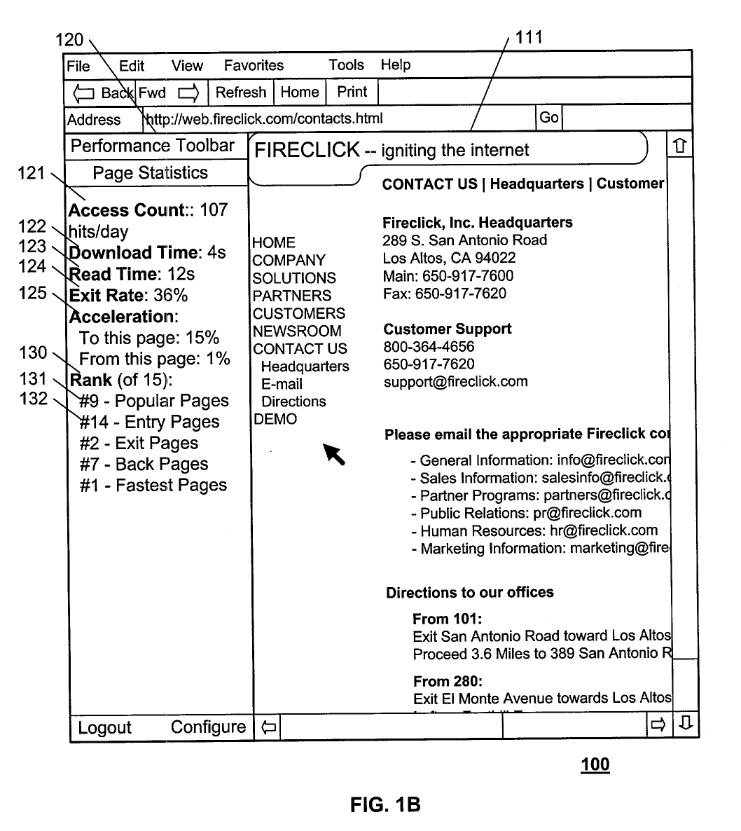

FIGS. 1A and 1B illustrate views of a display 100 that simultaneously contains the content of a web-page and performance data associated with the same web-page. As will be evident to one of ordinary skill in the art in view of this disclosure, any number of choices of location and format for this simultaneous display can be made, and the particular appearance of the display 100 in the figures is presented herein for illustrative purposes.

FIG. 1A illustrates an example browser display of a web-page 110. In accordance with this invention, a toolbar 120 is provided that is synchronized with the browser display. As the user navigates among pages of select web-sites, the performance of the currently displayed page is displayed in the toolbar 120. In this manner, the user is provided a simultaneous view of the contents of the web-page and the performance data related to the web-page.

The simultaneous view of the performance of the web-page while the browser displays the content of the web-page eases the task of retrieving web-page performance data, and avoids the disassociation that is common when the user is presented performance data associated with a name of a web-page. In a conventional, non-simultaneous display of performance data, the user must remember, or imagine, the contents of the named web-page, or must refer to other sources to form the association. In the example of FIG. 1A, for example, the web-page 110 is titled “Solutions”. In a conventional, non-simultaneous display of performance data, the display contains the name of the web-page, “Solutions”, and the statistics related to the page. Generally, the user is expected to be able to associate the performance data with the actual page, based on the name alone. If the user's recollection is poor, due perhaps to an infrequent need to assess the performance data, the user will generally refer to a collection of print-outs of the pages of the web-site, or may access the page via the Internet using a separate process, assuming that the name of the page that is used in reporting the performance data is consistent with a naming convention for the page on the web-site.

The performance data that is displayed regarding the web-page is dependent upon the information available regarding the web-page. In a conventional web-page performance system, each visit to the web-page is monitored, and data is collected. In a simple embodiment of a data-collection system, the number of times that the web-page is visited (the number of “hits” to the web-page) is recorded. Depending upon the particular collection system, the reported performance data may merely include the total number of hits since the deployment of the web-page, or it may provide hit-rates based on defined time periods, such as average hits-per-day (121 in FIG. 1A), histograms of hits-per-hour across a twenty-four hour period, and so on. In the aforementioned Netflame™ product, the time required to download the web-page at each visit is recorded, as is the connection speed of the visit, the duration of each visit to the web-page (“read” FIG.time), and so on. The aforementioned copending application, “WEB-SITE ANALYSIS SYSTEM”, teaches the collection and reporting of data related to the “depth” of a web-page, as measured by the number of traversals, or the time duration, between the commencement of the visit to the web-site and the arrival at the particular web-page. Other performance measures, such as the time required to effect a “checkout” from a purchase-site, the percentage of times that the web-page is the entry or exit page from the web-site, the number of times the visitor backtracks from the web-page, and so on, are also taught in this copending application.

Copending U.S. patent application, “DYNAMIC PATH ANALYSIS”, Ser. No. ______, filed ______ for Stephane Kasriel and Sara Swanson, Attorney Docket FC020117, discloses a path analysis system that allows a user to “filter” the collected data and/or the reported analysis information based on particular conditions, such as a time-frame of interest, characteristics associated with the visitor, how the visitor arrived at the site, and so on, and is incorporated by reference herein. Such filtering is often used to determine the effectiveness of a particular marketing strategy, or to evaluate the effects of changes made to the web-pages of a web-site. A preferred embodiment of this invention includes an embodiment of the filtering capabilities as taught in this copending application. Preferably, sets of filter conditions are saved as individual “campaigns”, and the user is provided the option of selecting a particular campaign from among a list of current campaigns. Thereafter, the displayed performance data corresponds to data that satisfies the conditions of the selected campaign.

The example of FIG. 1A illustrates the display of the average download time 122, and the read time 123, based on collected data, which may be filtered or unfiltered, depending upon whether the user has selected a set of conditions to apply to filter the collected data. The example of FIG. 1A also illustrates the display of the relative frequency of exits 124 from the web-site from the currently displayed page, and the relative acceleration 125 that was achieved by pre-downloading the page while the visitor was at another page, and the acceleration that was achieved by pre-downloading subsequent pages while at this page. Note that some of the displayed performance parameters may correspond to a composite of multiple performance parameters, and, in a preferred embodiment, the user is provided the option of selecting a displayed parameter to obtain a more detailed display of these multiple performance parameters. For example, the time to download a web-page includes the times required to find the web-server, establish a TCP connection, generate the content, receive the content, process the content and request images and other page objects, and so on. By clicking on the download time 122, the times required to effect each of these sub-tasks, or the relative percentage of the download time for each of these sub-tasks, are displayed. The display of other performance parameters will be evident to one of ordinary skill in the art in view of this disclosure.

To facilitate an assessment of the page in the context of the other pages on the web-site, the ranking 130 of the displayed page relative to the other pages for select measures is also displayed. In the example of FIG. 1A, the “Solutions” page 110 is the third most frequently visited page on the web-site (popularity 131), and is the second most frequently used page for entry to the web-site (entry 132). Measures of a page's performance also include how often the page is the last page that the visitor visits before exiting the web-site, how often the visitor employs the “back” button on the browser upon visiting the page, and others. Using these measures, marketers and webmasters can optimize the performance of the most popular pages, or introduce changes that encourage a visitor to remain at the web-site, and so on. Subsequent accesses to the performance data can be used to determine the effectiveness of such optimizations and changes.

In a preferred embodiment of this invention, the performance display toolbar 120 contains links to other web pages, to facilitate, for example, a more detailed analysis, alternative analyses, and so on. For example, in a preferred embodiment, each of the Rank 130 entries include links to a page that is configured to display the rankings of each of the pages of the site for the displayed parameter. For example, clicking on the popularity 131 parameter provides a display of a ranked listing of all the pages of the web-site and the frequency of visits to each page. Clicking on the acceleration 125 parameter provides access to other data related to acceleration, such as the rate of prediction success, the amount of data successfully pre-downloaded, and so on. In like manner, the toolbar 120 may provide access to other web-sites, using conventional techniques, such as HTML links, and so on. For example, the toolbar 120 may contact a commercial site that identifies all of the known web-sites that reference the displayed page, or, it may contact another site that identifies the known archives of the displayed page, and so on.

In like manner, the toolbar 120 in a preferred embodiment is configured to optionally launch other analysis tasks. For example, the selection of multiple campaigns, discussed above, provides for a simultaneous display of path-analysis information based on different sets of filter conditions. In this manner, a user can display, for example, a before-and-after comparison of path-analysis information, corresponding to different time-frame filter conditions. Or, the user may display a comparison of path-analysis as a function of the geographic location of visitors, or as a function of whether the visit resulted in a purchase, and so on.

As noted above, the toolbar 120 is synchronized to the actions of the user in the browser. Illustrated in FIG. 1A is a cursor arrow 190 that is above a hypertext link to the “Contact Us” web-page. When the user clicks on this link, the browser accesses the “Contact Us” web-page, as illustrated in FIG. 1B. In accordance with this invention, when the browser displays the new web-page (111 in FIG. 1B), the toolbar 120 is configured to automatically display the performance data 121-132 associated with this new web-page 111. As illustrated, for example, the average time to download 122 the “Contact Us” web-page is 4 seconds, compared to 12 seconds for the “Solutions” web-page 110 in FIG. 1A.

Of particular note, access to the performance data associated with the “Contact Us” web-page 111 is facilitated by merely clicking on the “Contact Us” hypertext link on the web-page 110 that is displayed by the browser, and the simultaneous display of the performance data and the content of the “Contact Us” web-page 111 automatically provides the association between the performance and the actual web-page, as discussed above, without requiring the user to remember or imagine what the web-page contains.

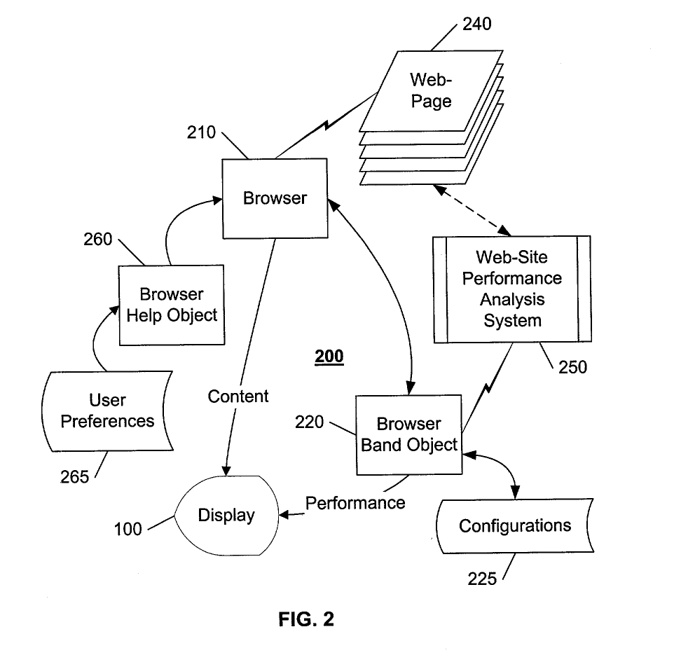

FIG. 2 illustrates an example block diagram of a web-site analysis system 200 that provides a coincident display of performance data related to a web-page 240 that is being displayed by a browser 210 in accordance with this invention. In a preferred embodiment of this invention, a “band object” 220 is used to synchronize the display of performance data with the display of the content (110, 111 of FIGS. 1A, 1B) of the web-page 240 by the browser 210. An icon is provided in the browser 210 for turning the band object 220 on and off.

As is known in the art, particularly with regard to the Microsoft Internet Explorer browser, a band object is a C++ COM dll that registers special keys in the registry to inform the browser that it is a band object. The browser is configured to display the name of the band object as a menu entry. When a user selects the band object from the menu, the browser invokes the band object via an entry to the C++ COM dll, and displays it. The user can subsequently hide the band object by closing it. A band object may host any windows control, and has programmatic access to the WebBrowser control of the main document being displayed by the browser, and can be configured to receive events from the main document.

In a preferred embodiment, the band object 220 is configured to display a WebBrowser control, which is a COM container for a web page, and is configured to receive events corresponding to the user clicking on a link within the main document. In this manner, the band object 220 is informed whenever the user selects a new page (110, 111 in FIGS. 1A, 1B) to be displayed by the browser 210, thereby providing synchronization with the browser 210.

The band object 220 is configured to access data from a web-site performance analysis system 250, such as the aforementioned Netflame™ analysis system. For the purposes of this disclosure, the performance-analysis system 250 may correspond to multiple performance-analysis systems. One system may be configured, for example, to record parametric data, such as the number of visits, the duration of visits, and so on, while another system may be configured to record information related to the visitors to the site, and yet another configured to record traversal information. Additionally, many systems provide “mirror” sites that are configured to contain the same information as the original site, and are designed to provide access to the information if the original site is unavailable, or overloaded.

As indicated by the dashed arrow, the analysis system 250 collects data regarding visits to select web-pages 240. A web-site provider subscribes to receive the services of the analysis system 250, and identifies the web-pages 240 of the web-site for which performance data is to be collected. As noted above, the aforementioned copending U.S. patent application, “DYNAMIC PATH ANALYSIS” discloses a traffic and performance analysis system that allows a user to filter the data related to visits to a web-site, to allow for targeted analysis periods, or to target visits to or from select sites or pages. In a preferred embodiment of this invention, the user is provided the option of predefining particular configurations 225 of the displayed performance data, or storing the configuration of currently selected display options and formats for subsequent use.

Preferably, the analysis system 250 contains an application program that is configured to provide requested performance data, typically a DHTML/Javascript/Java applet application. Correspondingly, the band object 220 hosts a web page that contains program code, typically Javascript/Java code, that invokes the application at the analysis system 250 to extract the performance data from the analysis system 250 corresponding to the page (110, 111 in FIGS. 1A, 1B) that is currently being displayed by the browser 210. As noted above, the band object 220 receives event-notifications of user clicks from the browser 210, and is thus aware of each web-page selection via the browser 210. The program code at the band object 220 preferably writes the received performance data as DHTML content, for display within the window (120 in FIGS. 1A, 1B) associated with the band object 220.

Also illustrated in FIG. 2 is an optional browser helper object 260 that is configured to facilitate the implementation of user preferences 265.

In a typical browser environment, helper objects are always invoked when the browser is started, whereas a band object is invoked only if it had been invoked when the browser was last exited. Other default behavior may also be associated with the initiation of the browser.

To facilitate custom control of the analysis system 200, the browser helper object 260 of this invention accesses the user preferences 265 and subsequently issues commands to the browser 210 to effect these preferences 265, independent of the default behavior of the browser 210. For example, a user may prefer that the band object 220 is always invoked, or never invoked, when the browser 210 is started, independent of whether the band object 220 had been invoked when the browser 210 was last exited. Similarly, the user may prefer that the band object be invoked under certain circumstances, but not others. For example, the user may choose to invoke the band object 220 whenever the user is browsing an “analysis-enabled” web-site, or web-page, and to disable the band object 220 whenever the user traverses to another web-site.

The foregoing merely illustrates the principles of the invention. It will thus be appreciated that those skilled in the art will be able to devise various arrangements which, although not explicitly described or shown herein, embody the principles of the invention and are thus within its spirit and scope. For example, although the use of a band object and helper object have been found to be particularly effective and efficient for embodying this invention, other techniques for synchronizing the behavior of a performance display object and a web page display object may be employed. A variety of system configuration and optimization features will be evident to one of ordinary skill in the art in view of this disclosure, and are included within the scope of the following claims.

I claim:

1. An analysis system, comprising:
an interface that is configured to facilitate a selection of a web-page, and
a first display component that is configured to effect a display of contents of the web-page, in response to the selection of the web-page, and
a second display component that is configured to effect a display of performance data associated with the web-page, also in response to the selection of the web-page.

2. The analysis system of claim 1, wherein
the performance data includes at least one of:
a count of prior accesses to the web-page,
one or more measures of time duration corresponding to the prior accesses to the web-page,
one or more first statistics corresponding to activities prior to the prior accesses to the web-page, and
one or more second statistics corresponding to activities subsequent to the prior accesses to the web-page.

3. The analysis system of claim 2, wherein
the one or more measures of time duration include at least one of:
a measure of time consumed downloading the web-page, and
a measure of time between entry to and departure from the web-page.

4. The analysis system of claim 2, wherein
the web-page is one of a plurality of pages of a web-site, and
the activities prior to the prior accesses correspond to at least one of:
accesses from other pages of the plurality of pages, and
entries to the web-site.

5. The analysis system of claim 2, wherein
the web-page is one of a plurality of pages of a web-site, and
the activities subsequent to the prior accesses correspond to at least one of:
accesses to other pages of the plurality of pages, and
departures from the web-site.

6. The analysis system of claim 1, wherein
the web-page is one of a plurality of pages of a web-site, and
the performance data includes data relative to accesses to other pages of the plurality of pages of the web-site.

7. The analysis system of claim 6, wherein
the data relative to the accesses to other pages is based upon at least one of:
frequency of access,
frequency of entries to the web-site,
frequency of exits from the web-site,
frequency of use of a back button to terminate access, and
speed of downloading.

8. The analysis system of claim 1, wherein
the second display component is also configured to provide links to other web-pages.

9. The analysis system of claim 1, wherein
the second display component is configured to display the performance data based upon information received from a performance analysis system.

10. The analysis system of claim 1, further including
a starter component that is configured to start the second display component, based on a user-defined criteria.

11. The analysis system of claim 10, wherein
the user-defined criteria includes at least one of:
a commencement of the first display,
the selection of the web-page, and
a selection of a web-site associated with the web-page.

12. The analysis system of claim 10, wherein:
the first display component includes a browser,
the second display component includes a browser band object, and
the starter component includes a browser helper object.

13. The analysis system of claim 1, wherein:
the first display component includes a browser, and
the second display component includes a browser band object.

14. The analysis system of claim 1, further including
a filter component that is configured to filter the performance data, based on one or more user-defined conditions.

15. The analysis system of claim 14, wherein
the one or more user-defined conditions include at least one of:
a time-frame,
a characteristic of visitors to the web-page, and
an origination of visits to the web-page.

16. The analysis system of claim 1, wherein
the performance data corresponds to a plurality of performance measures,
at least one performance measure of the plurality of performance measures includes a plurality of sub-measures, and
the analysis system is further configured to effect a display of the plurality of sub-measures upon a selection of the at least one performance measure.

17. The analysis system of claim 1, wherein
the performance data includes at least one of:
a measure of depth of the web-pages, corresponding to a number of visits to other web pages of the web-site during an access to the web-site that includes a visit to the web-page, and
a measure of depth-time of each web page of the one or more web-pages, corresponding to a time duration of visits to other web pages of the web-site during an access to the web-site that includes a visit to the web-page.

18. A method of providing performance data associated with a web-page, including:
displaying content material associated with the web-page, and, simultaneously,
displaying the performance data associated with the web-page.

19. The method of claim 18, wherein
the performance data includes at least one of:
a count of prior accesses to the web-page,
one or more measures of time duration corresponding to the prior accesses to the web-page,
one or more first statistics corresponding to activities prior to the prior accesses to the web-page, and
one or more second statistics corresponding to activities subsequent to the prior accesses to the web-page.

20. The method of claim 19, wherein
the one or more measures of time duration include at least one of:
a measure of time consumed downloading the web-page, and
a measure of time between entry to and departure from the web-page.

21. The method of claim 19, wherein
the web-page is one of a plurality of pages of a web-site, and
the activities prior to the prior accesses correspond to at least one of:
accesses from other pages of the plurality of pages, and
entries to the web-site.

22. The method of claim 19, wherein
the web-page is one of a plurality of pages of a web-site, and
the activities subsequent to the prior accesses correspond to at least one of:
accesses to other pages of the plurality of pages, and
departures from the web-site.

23. The method of claim 18, wherein
the web-page is one of a plurality of pages of a web-site, and
the performance data includes data relative to accesses to other pages of the plurality of pages of the web-site.

24. The method of claim 23, wherein
the data relative to the accesses to other pages is based upon at least one of:
frequency of access,
frequency of entries to the web-site,
frequency of exits from the web-site,
frequency of use of a back button to terminate access, and
speed of downloading.

25. The method of claim 18, further including
receiving the performance data from a performance analysis system.

26. The method of claim 18, further including
filtering the performance data, based on one or more user-defined conditions.

27. The method of claim 26, wherein
the one or more user-defined conditions include at least one of:
a time-frame,
a characteristic of visitors to the web-page, and
an origination of visits to the web-page.

28. The method of claim 18, further including:
displaying additional performance data associated with a selected item of the performance data.

29. The method of claim 18, wherein
the performance data includes at least one of:
a measure of depth of the web-page, corresponding to a number of visits to other web pages of the web-site during an access to the web-site that includes a visit to the web-page, and
a measure of depth-time of the web-page, corresponding to a time duration of visits to other web pages of the web-site during an access to the web-site that includes a visit to the web-page.

30. A method of providing a web-analysis service, including:
providing a performance display system that is configured to be operably coupled to a web-page display system that displays contents of a web-page,
wherein
the performance display system is configured to display performance data associated with the web-page, while the contents of the web-page are displayed by the web-page display system.

31. The method of claim 30, wherein
the performance data includes at least one of:
a count of prior accesses to the web-page,
one or more measures of time duration corresponding to the prior accesses to the web-page,
one or more first statistics corresponding to activities prior to the prior accesses to the web-page, and
one or more second statistics corresponding to activities subsequent to the prior accesses to the web-page.

32. The method of claim 31, wherein
the one or more measures of time duration include at least one of:
a measure of time consumed downloading the web-page, and
a measure of time between entry to and departure from the web-page.

33. The method of claim 31, wherein
the performance data includes at least one of:
a count of prior accesses to the web-page,
one or more measures of time duration corresponding to the prior accesses to the web-page,
one or more first statistics corresponding to activities prior to the prior accesses to the web-page, and
one or more second statistics corresponding to activities subsequent to the prior accesses to the web-page.

34. The method of claim 33, wherein
the one or more measures of time duration include at least one of:
a measure of time consumed downloading the web-page, and
a measure of time between entry to and departure from the web-page.

35. The method of claim 34, wherein
the web-page is one of a plurality of pages of a web-site, and
the activities prior to the prior accesses correspond to at least one of:
accesses from other pages of the plurality of pages, and
entries to the web-site.

36. The method of claim 31, wherein
the web-page is one of a plurality of pages of a web-site, and
the activities subsequent to the prior accesses correspond to at least one of:
accesses to other pages of the plurality of pages, and
departures from the web-site.

37. The method of claim 30, wherein
the web-page is one of a plurality of pages of a web-site, and
the performance data includes data relative to accesses to other pages of the plurality of pages of the web-site.

38. The method of claim 37, wherein
the data relative to the accesses to other pages is based upon at least one of:
frequency of access,
frequency of entries to the web-site,
frequency of exits from the web-site,
frequency of use of a back button to terminate access, and
speed of downloading.

39. The method of claim 30, further including
receiving the performance data from a performance analysis system.

40. The method of claim 30, further including:
providing a performance analysis system that is configured to collect information during accesses to the web-page, and to provide the performance data to the performance display system based on the information that is collected.

41. The method of claim 30, wherein
the performance display system is further configured to
filter the performance data, based on one or more user-defined conditions.

42. The method of claim 41, wherein
the one or more user-defined conditions include at least one of:
a time-frame,
a characteristic of visitors to the web-page, and
an origination of visits to the web-page.

43. The method of claim 30, wherein
the performance display system is further configured to
display additional performance data associated with a selected item of the performance data.

44. The method of claim 30, wherein
the performance data includes at least one of:
a measure of depth of the web-page, corresponding to a number of visits to other web pages of the web-site during an access to the web-site that includes a visit to the web-page, and
a measure of depth-time of the web-page, corresponding to a time duration of visits to other web pages of the web-site during an access to the web-site that includes a visit to the web-page.
